(19) United States
(12) Patent Application Publication
(10) Pub. No.: US 2015/0058255 A1
(43) Pub. Date: Feb. 26, 2015

(54) SYSTEM AND METHOD FOR RESTAURANT RATING

(71) Applicant: Stephen Cork, Franklin, TN (US)

(72) Inventor: Stephen Cork, Franklin, TN (US)

(21) Appl. No.: 14/463,963

(22) Filed: Aug. 20, 2014

Related U.S. Application Data
(60) Provisional application No. 61/867,694, filed on Aug. 20, 2013.

(51) Int. Cl. G06Q 30/02; G06Q 50/12

(52) U.S. Cl. CPC G06Q 30/0282; G06Q 50/12
USPC 705/347

(57) ABSTRACT

The present invention is a system and method for receiving patron ratings of an establishment, analyzing those ratings and providing an indication of the ratings to persons and organizations responsible for the operation of the establishment. The system and method is configured to provide these ratings in a real-time manner to allow corrective actions to be taken within a short period of time to mitigate the negative impact to the establishment's reputation among patrons.

### CROSS-REFERENCE TO RELATED APPLICATION

This application claims priority to provisional application 61/867,694 filed on Aug. 20, 2013 and is herein incorporated by reference in its entirety.

### BACKGROUND AND SUMMARY OF THE INVENTION

Exemplary embodiments of the present invention relate generally to systems and methods for rating restaurant services.

The restaurant industry is highly competitive and as such, it may be critical for a restaurateur to receive timely feedback from patrons in order to identify and address any negative trends or unfavorable patron experiences before they result in damage to an establishment's reputation and loss of business. Known methods of collecting feedback from patrons include comment cards, telephone surveys, internet surveys performed after a patron's restaurant visit, email or postal mail surveys, and direct feedback to restaurant personnel in response to questions about food and service. With the exception of comment cards and direct feedback methods, restaurants generally do not receive feedback from patrons until after they depart from the restaurant. As a result of time delays or direct contact with restaurant personnel, such methods are not able to provide the quick and unbiased response needed to accurately gauge patron satisfaction. Another known method of collecting patron feedback is online rating web sites. These sites may provide relatively unbiased patron feedback but, as with surveys, the data is collected after the patron has left the restaurant or establishment. In many cases, such data is not collected until days later. When using known internet rating methods, the ratings and comments are often released to the public shortly after such feedback is received. This public release does not allow the restaurateur to identify and react to a problem before release and may result in damage to an establishment's reputation that is difficult to overcome. What is needed is a system and method for collecting patron feedback and providing it directly to the restaurateur in a manner that is convenient for the patron and which allows for an anonymous response to encourage frank and honest feedback.

Embodiments of the present invention may be implemented using a web site accessible to mobile devices. Other embodiments of the invention may be implemented using one or more mobile device applications (Apps) that may be installed on mobile devices. In certain embodiments of the invention, the system may be configured to provide an incentive to the patron in exchange for submitting a review. These incentives may include, but are not limited to, discount coupons, coupons for free food items or services, and invitations to special events. Incentives may be delivered to the patron via email, a web page, or within an App. In embodiments of the invention, the restaurateur may configure the system to deliver information submitted by patrons to an email address, web site, or an App. Embodiments of the invention may be implemented using web servers, cloud services, or may be installed on a personal computer or mobile device.

In addition to the features mentioned above, other aspects of the present invention will be readily apparent from the following descriptions of the drawings and exemplary embodiments, wherein like reference numerals across the several views refer to identical or equivalent features, and wherein:

### BRIEF DESCRIPTION OF THE DRAWINGS

FIG. 1 is a diagram of a computer configured to implement an embodiment of the invention;

FIG. 2 is a graphic diagram of an exemplary embodiment of the invention;

FIG. 3 is an illustration of a screen image of an exemplary embodiment of the invention running on a mobile device;

FIG. 4 is an illustration of a screen image of an exemplary embodiment of the invention illustrating the results of a review delivered to restaurateur; and

FIG. 5 is a flow chart of an embodiment of the invention.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Exemplary embodiments of the present invention are directed to systems and methods of receiving feedback from restaurant patrons and providing that feedback to a restaurateur to allow the restaurateur to reinforce favorable service behavior and food preparation methods. Patron feedback may be helpful to identify areas of service weakness and correct unfavorable service behavior before such weaknesses and behavior result in unhappy patrons. In addition to restaurant implementations, embodiments of the invention may be adapted to provide feedback on other service industries including, but not limited to, beauty salons, hotels and other lodging, and repair services.

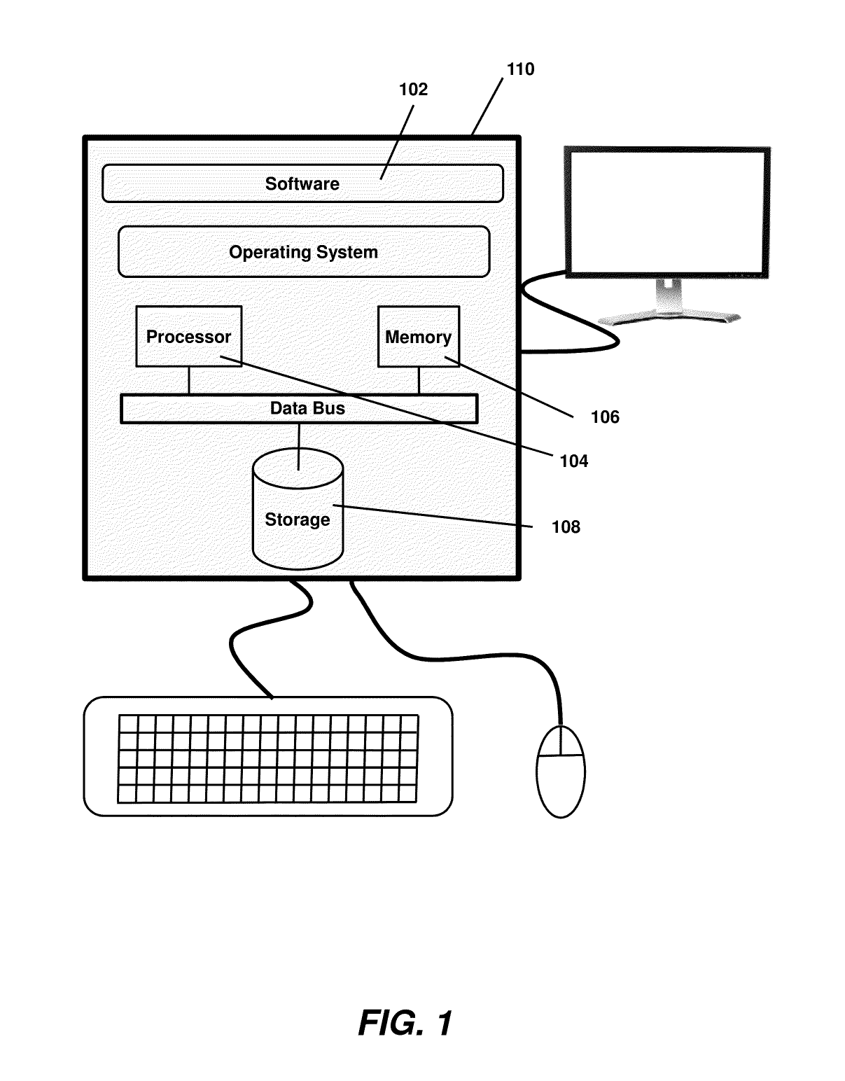

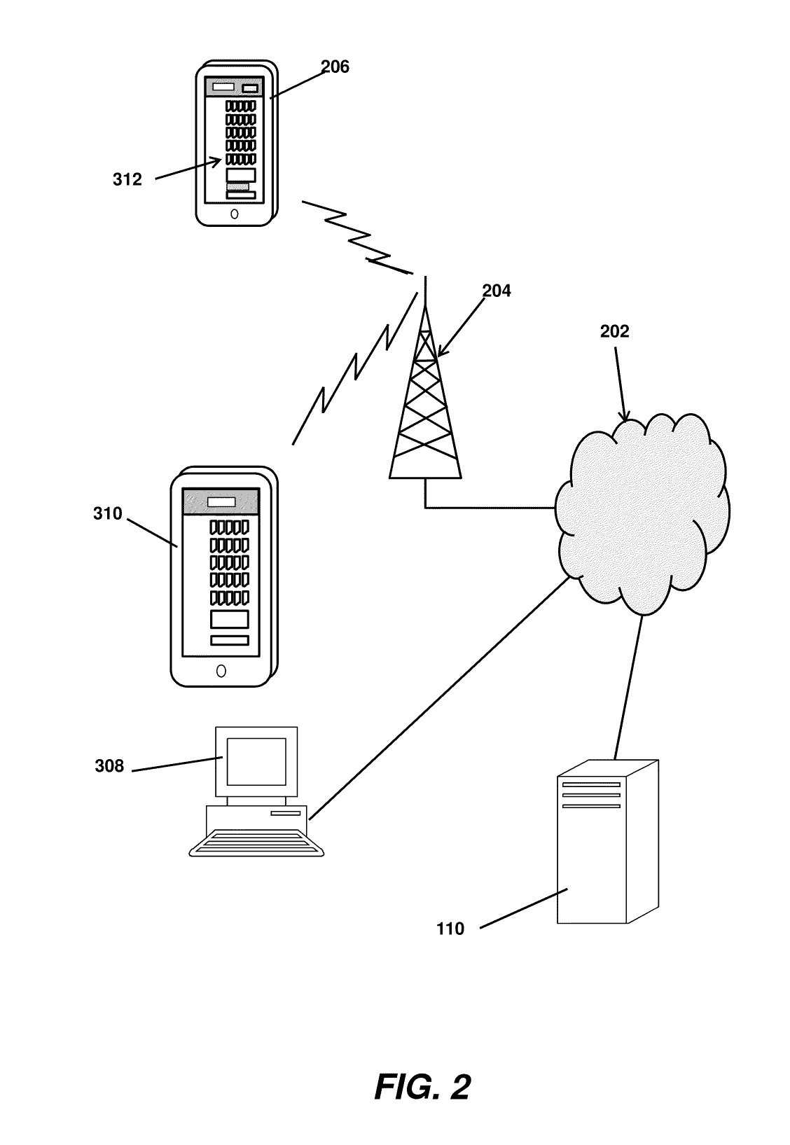

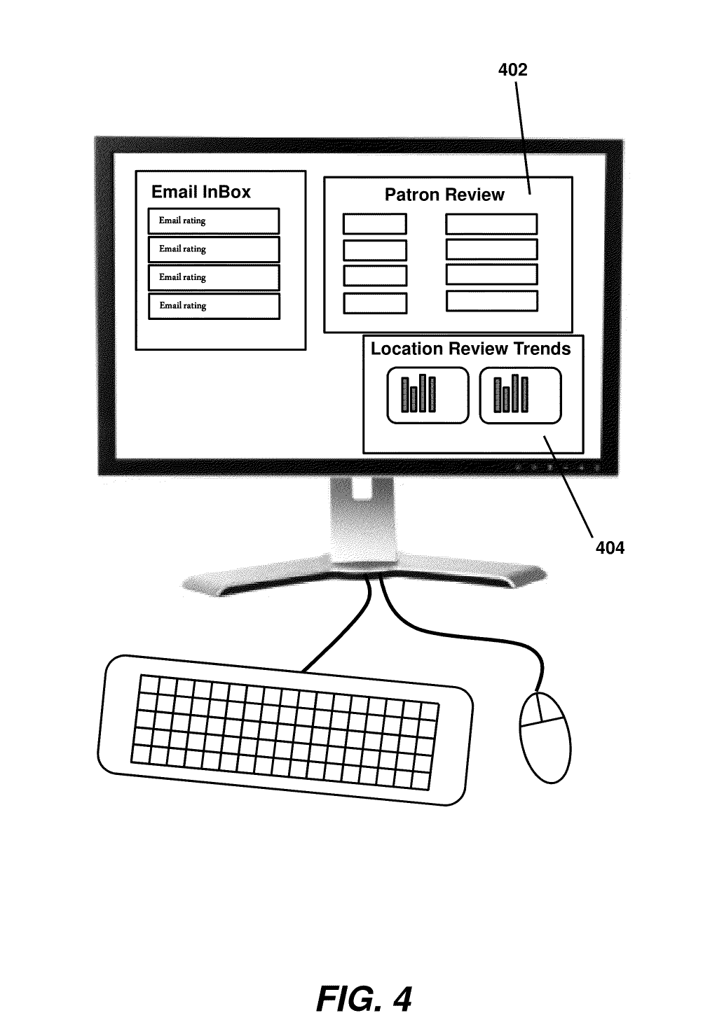

Referring to FIG. 1, some embodiments of the invention may utilize software 102 to configure a computer server 110 or other computerized device to perform certain steps of the invention. The processor 104 may be configured by software 102 to maintain an interface which may receive input from one or more patrons as part of the process illustrated in FIG. 4. Information received from the interface may be stored in memory 106, a storage device 108, or both. Software 102 may be executed by the processor 104 to generate emails, instant messages (i.e. text messages), or other notifications as the result of analysis of the input from one or more patrons. Such analysis may be stored in memory 106 or the storage device 108 for later retrieval. Such a computer server 110 may be configured to send and receive data from mobile computing applications executing on mobile computing devices. As illustrated in FIG. 2, such data may be communicated using computer networks 202 and cellular data networks 204.

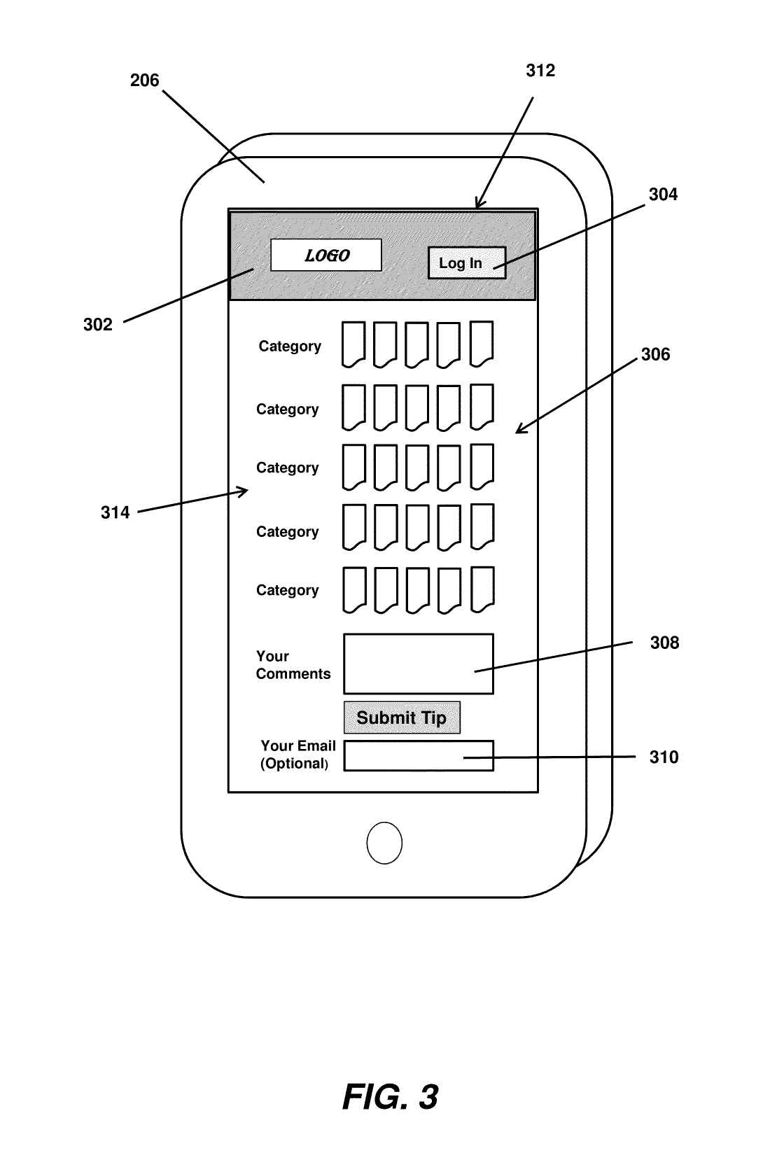

Referring to FIG. 2, which illustrates an exemplary embodiment of the invention, a patron may visit a web site or run an application on a mobile computing device 206 to provide a rating or review. The mobile computing device may display a rating and comment input user interface as illustrated in FIG. 3. As shown in FIG. 3, such a user interface may comprise a header 302, the option to log in 304, a ratings section 306, a comments section 308, and an email address entry area 310. Referring again to FIG. 2, the mobile computing device 206 may communicate ratings and other information input by a patron using a cellular data network 204 through a computer network such as the internet 202, to a computer server 110 which may be executing a software program embodying steps necessary to perform embodiments of the invention. Mobile computing devices may also be configured to communicate using wireless networks (“Wi-Fi”). In such configurations the mobile device may communicate without requirement for a cellular data network.

The computer server 110 may communicate ratings and other information using a computer network such as the internet 202 to a computer 308 or via a cellular data network 204 to a second mobile computing device 310. By the communication of food and service reviews in such a manner, embodiments of the invention may enable persons responsible for managing the quality of food and service at a restaurant or other service establishment (restaurateurs) to quickly react to patron or customer feedback.

Restaurant patrons may learn of embodiments of the invention as the result of notices or placards placed on their table. Alternative methods may include, without limitation, notices printed on menus or message cards placed in a bill folder when it is delivered to a patron for payment. Referring again to FIG. 3, in embodiments of the invention a patron may cause their mobile device to navigate to a web page 312 for entry of a review. In the exemplary web page illustrated, a header 202 may be displayed which identifies the web site and provides an opportunity to log in 304. Other embodiments of the invention may utilize an App executing on a mobile device 206. In such embodiments, the App may send and receive information to and from an interface in communication with the computer server 110. Embodiments of the invention that are enabled using an App may have the benefit of access to mobile device hardware such as location systems, to better locate an establishment to be rated, as will be described herein. Logging in may allow for some information to be pre-populated based on patron preferences. In some embodiments of the invention, logging in may allow a patron to view available incentive offers as described below.

Embodiments of the invention may allow the patron to select from a list of establishments enrolled to receive patron ratings. Alternatively, embodiments of the invention may enable a location services function on mobile devices to identify the location of the patron. Such a location may be used to narrow the list of nearby establishments or identify the establishment from the location of the patron. In certain embodiments of the invention, nearby establishments may be retrieved from third-party geo locator data systems. An example of such a geo locator data system is “Google Places” (Google Inc., Mountain View, Calif.), other geo locator data systems are or may become available and may be employed in embodiments of the invention to assist the user in the identification of the restaurant for which the user wishes to submit a review or comment.

In embodiments of the invention, the notices, placards, or message cards may include a location-specific web address which may direct the patron's mobile device directly to a rating entry web page that is specific to the establishment where the patron viewed or received the notices, placards, or message cards. Embodiments of the invention may utilized machine readable codes (examples include, without limitation, bar or “OR” codes) printed on notices, menus, placards, message cards or other surfaces. Widely available bar code or QR code reader software applications may be utilized to direct the patron's mobile device to a rating web page configured to receive patron feedback for an establishment identified by the machine readable bar or QR code. Embodiments of the invention are configured to use mobile Apps to receive patron feedback, the mobile App may configure a mobile computing device to receive a machine readable code. Once such a code has been received, the mobile App may configure the mobile computing device to receive patron feedback for an establishment identified by the machine readable code. Such embodiments eliminate the need to locate the establishment to be rated using location services, entry of an identifier, or manual selection of the establishment.

When the establishment to be rated is identified, a rating entry page 312 may be presented to the patron. Such a ratings entry page may include categories of service available for rating 314. Such categories may comprise food quality, cleanliness, value, and overall rating. Other categories may be included depending upon the type of establishment being rated or areas of concern to the restaurateur. Examples of other such categories, without limitation, may comprise speed of service, professionalism, and such service related categories as problems identified and fixed. It will be understood by one ordinarily skilled in the art that categories of patron or client feedback are virtually limitless and therefore, embodiments of the invention may be configured to accept feedback on a wide range of performance and satisfaction characteristics.

Certain embodiments of the invention may be implemented to allow a patron to provide reviews and ratings of restaurant servers. In such an implementation, servers that are employed at an establishment may enroll or be enrolled such that their names may appear in a list presented to the patron during the review process. In such an implementation, a patron may be presented with a list of servers who have enrolled and are associated with the restaurant or establishment selected for review. A patron may select a server from the list and provide a review of the server's performance. Example server ratings may comprise accurate entry of patron's order, responsiveness, friendliness, prompt service, and adequacy of checking back with patron at regular intervals during the meal. In such an embodiment, the review of the server's performance may be communicated to the server, the server's supervisor, or both. Embodiments of the invention may compile server performance reviews such that summaries of the reviews may be viewed or retrieved in order to assist in the creation of performance reviews by server supervisors. Embodiments of the invention may be configured to allow viewing or retrieval of server performance reviews by the servers reviewed. If desired, such a configuration may be used by a server to create a resume or other performance record.

As was noted earlier herein, embodiments of the invention may be implemented using mobile device Apps. In such an embodiment, a patron may be prompted to install a software application on their mobile device or to open such an application that has previously been installed. As described with regard to navigating to a rating web page earlier in this discussion, such an application may provide lists of establishments, enable location services, or read a machine readable code (examples include, without limitation, bar codes and QR codes), or manually entered code to identify the establishment, server, or both that the patron wishes to rate using an embodiment of the invention. Mobile device applications may be configured to allow a patron to store log on information and restaurant ratings on a mobile device. Additionally, mobile device applications may be configured to receive and store offers and incentives from restaurateurs or other merchants. Mobile device applications may also use geo locator data systems to show nearby restaurants and provide information about such restaurants such as menu information and reviews selected for publication by a restaurateur. Mobile devices frequently contain information that could be used to identify the user of such a device. As a result, many users may be hesitant to provide reviews, ratings, and comments out of concern that such ratings and comments are not anonymous as a result of the information contained by the mobile device. To encourage feedback, embodiments of a mobile App may be configured to present the patron with the option of filing his or her reviews, ratings, and any comments anonymously.

Embodiments of the invention may be configured to offer an incentive to the patron in exchange for a review of the establishment. In such an embodiment, when the patron has submitted a review, the patron may be presented with an award of free or discounted food, services, or merchandise. In other embodiments, a patron may collect points which may be allowed to accumulate and exchanged at a later date for items such as food, merchandise, services, or admittance to special events. In certain embodiments, such incentives may be distributed directly on a web page as an image which may be shown to a restaurant or other merchant. Embodiments of the invention may be configured to send an email message to the patron. Such an email message may contain details of the incentive offered. Embodiments of the invention may be configured to send instant messages to the patron's mobile device. As with email messages, such instant messages may contain details of the incentive offered. In embodiments of the invention which utilize mobile device applications, offers may be transmitted to and stored within the application for later retrieval by a patron.

Embodiments of the invention may be configured to provide email messages to one or more recipient email addresses preselected by the restaurateur. Referring to FIG. 4, which illustrates an exemplary email message. Such email messages may be configured to display patron ratings 402 for each review submitted. Alternatively, embodiments of the invention may be configured to provide aggregated reporting to a restaurateur or other designated party into email messages delivered at preset time intervals. Embodiments of the invention may also be configured to send instant messages containing patron ratings. In preferred embodiments, these messages as well as email messages containing patron ratings are delivered real-time. In this instance, real-time means in a time frame such that a person or persons responsible for managing the operations of an establishment may be able to receive such a message and rapidly begin to take actions intended to address the circumstances that may have caused the negative patron ratings. Ideally, the time frame will be short enough that the circumstances are able to be addressed and corrected before other patrons experience dissatisfaction. In some embodiments of the invention, such messages may be configured to provide aggregated data at preselected time intervals. These email and instant message aggregated message configurations may be utilized to reduce the number of emails or instant messages received while allowing the recipient to view and react to unfavorable trends.

Reports provided to a restaurateur may contain data collected from a plurality of reviews submitted over a period of time. Such reporting may be used to track and identify trends in submitted reviews. Examples of such trends may include, but are not limited to, the quality of service ratings for specific periods of time during the day or week, quality of food for specific periods of time, number of reviews received, number of reviews per server, and average overall satisfaction. Trend data may be delivered via an email message 404. Embodiments of the invention may be configured using a software application running on a restaurateur's computing device 308. In such embodiments, the software application may be configured to receive, store, and display review data on the computing device 308 such that the data can be viewed without a continuous connection to a web page or computer server 110.

Embodiments of the invention may be configured to identify particularly favorable or unfavorable reviews and highlight such reviews to make them readily identifiable for the recipient. An example of such highlighting may be a configuration that sends aggregated reviews at an hourly time interval but sends an instant message to the recipient if an unfavorable review is submitted. Such a highlighting process may allow the recipient to identify and correct the cause of the unfavorable review before the patron has left the reviewed establishment.

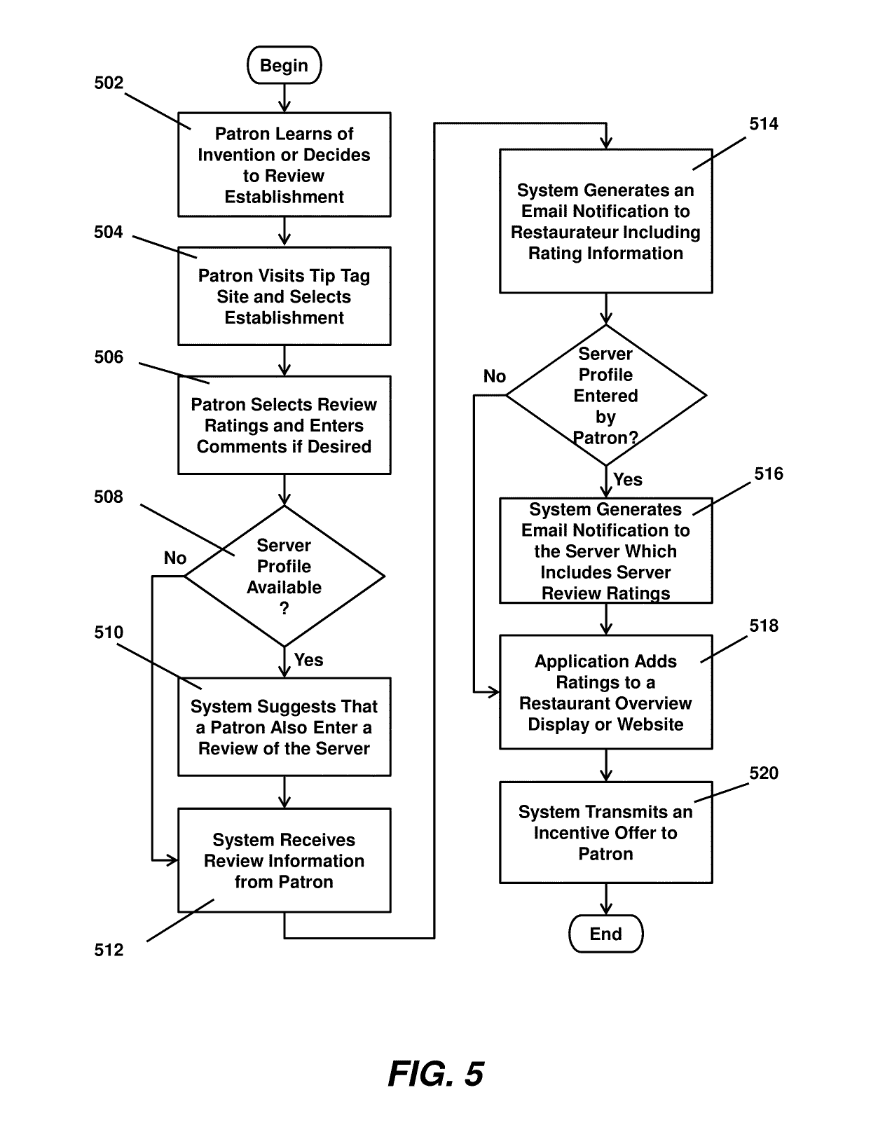

Referring to FIG. 5, which is a flow chart of the steps involved in practicing an exemplary embodiment of the invention. In step 502 a patron may become aware of an embodiment of the invention as the result of a placard, insert, or method of promoting the embodiment. The patron may then visit a web site or mobile App to provide a rating of the restaurant or other establishment 504. Once the establishment has been identified by the patron, the patron may be presented with a list of rating categories. The patron may then enter review ratings and comments 506. If the system identifies server profiles associated with the selected establishment 508, the patron may be prompted with a suggestion to select a server from a list of servers associated with the establishment 510 and provide an additional review of the server's performance. When the patron has entered his or her ratings and any comments, the system may prompt the patron to submit the ratings. When submitted, the embodiment may communicate the ratings, comments and other information disclosed by the patron to a computer server 110 or other device which has been configured to receive such communications 512. The computer server 110 may then generate email or other notifications to the restaurateur or other recipient 514. If a server profile was selected by the patron the system may be configured to generate email notifications to the selected server 516. Such email notifications may include server review ratings for the selected server. Certain embodiments of the invention may be configured to generate overview web sites or other displays. In such embodiments, a restaurateur or other party may view such overview displays in order to obtain an overview or summary of reviews received by a restaurant or other establishment. Step 518 illustrates a step in which an embodiment may add information to such an overview display. In step 520 an embodiment of the invention may transmit a promotional offer or other incentive to the patron in response to the receipt of a review from that patron.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A computerized system for collection patron feedback and providing that patron feedback to a restaurateur in real-time comprising:
a computer system comprising a processor, a memory device, and a storage device;
an interface in communication with the computer system adapted to receive patron feedback using the internet;
software instructions which when executed by the processor, configure the computer system to receive patron feedback;
software instructions which, when executed by the processor, analyze the patron feedback received by the computer system; and
software instructions which, when executed by the processor, provide the analyzed feedback in real-time to at least one recipient predetermined by the restaurateur.

2. The computerized system of claim 1, where the software instructions which configure the computer system to receive patron feedback, comprise instructions which form a web page adapted for use by a mobile computing device.

3. The computerized system of claim 2, where the software instructions which form a web page, further comprise:
software instructions which, when executed by the processor of a mobile computing device, configure the mobile computing device to provide data identifying its geographic location;
software instructions which, when executed by the processor of the computer system, cause the computer system to receive data from the mobile computing device that identifies the geographic location of the mobile device;
software instructions which, when executed by the processor of the computer system, cause the computer system to search a database of establishments and identify the establishments within a predetermined distance from the mobile device;
software instructions which, when executed by the processor of the computer system, cause the computer system to form a list of the identified establishments on the web page.

4. The computerized system of claim 2, where the software instructions which form a web page, further comprise:
software instructions which, when executed by the processor of the computer system, cause the computer system to receive an establishment identifier from the mobile computing device; and
software instructions which, when executed by the processor of the computer system, cause the computer system to search a database of establishments and identify the establishment indicated by the received establishment identifier.

5. The computerized system of claim 1, also comprising:
software instructions which, when executed by the processor of the computer system, cause the processor to transmit a predetermined incentive offering to the patron after the receipt of patron feedback by the computer system.

6. The computerized system of claim 1, where the software instructions which provide the analyzed feedback in real-time to at least one recipient predetermined by the restaurateur comprise software instructions that:
configure the processor to form a web page, accessible to recipients predetermined by the restaurateur; and
configure the processor to display the analyzed feedback in the formed web page.

7. The computerized system of claim 1, where the software instructions which provide the analyzed feedback in real-time to at least one recipient predetermined by the restaurateur comprise software instructions that configure the processor to accumulate the analyzed feedback data and after a predetermined time interval, transmit a message to at least one predetermined recipient comprising a summary of the analyzed feedback data.

8. The computerized system of claim 7, where the software instructions which provide the analyzed feedback in real-time to at least one recipient predetermined by the restaurateur further comprise software instructions that:
configure the processor to analyze the analyzed feedback data and identify feedback results which fall outside of a predetermined range; and
configure the processor to transmit instant messages to predetermined recipients if feedback is identified which falls outside of the predetermined range.

9. A computerized system for collecting patron feedback and providing that patron feedback to a restaurateur in real-time comprising:
a computer system comprising a processor, a memory device, and a storage device;
an interface in communication with the computer system adapted to receive patron feedback using the internet;
software instructions which when executed by the processor, configures the computer system to receive patron feedback;
software instructions which, when executed by the processor, analyze the patron feedback received by the computer system;
software instructions which, when executed by the processor, provide the analyzed feedback in real-time to recipients predetermined by the restaurateur; and
software instructions which, when executed by the processor of a mobile computing device, configure the mobile computing device to receive patron feedback and transmit the received feedback to the computer system.

10. The computerized system of claim 9, further comprising:
software instructions which, when executed by the processor of the mobile computing device, cause the mobile device to identify its geographic location and transmit that location to the computer system;
software instructions which, when executed by the processor of the computer system, cause the computer system to receive data from the mobile computing device that identifies the geographic location of the mobile device;
software instructions which, when executed by the processor of the computer system, cause the computer system to search a database of establishments and identify the establishments within a predetermined distance from the mobile device; and
software instructions which, when executed by the processor of the computer system, cause the computer system to transmit a list of the identified establishments to the mobile computing device.

11. The computerized system of claim 9, further comprising:
software instructions which, when executed by the processor of the mobile computing device, cause the mobile computing device to receive an establishment identification code;
software instructions which, when executed by the processor of the mobile computing device, cause the mobile computing device to transmit the establishment identification code entered by the user to the computer system; and
software instructions which, when executed by the processor of the computer system, cause the computer system to search a database of establishments and identify the establishment indicated by the received establishment identification code.

12. The computerized system of claim 9, further comprising:
software instructions which, when executed by the processor of the mobile computing device, cause the mobile computing device to receive a machine readable code which identifies a location;
software instructions which, when executed by the processor of the mobile computing device, cause the mobile computing device to transmit the machine readable code to the computer system; and
software instructions which, when executed by the processor of the computer system, cause the computer system to search a database of locations and identify the location indicated by the received machine readable code.

13. The computerized system of claim 9, also comprising:
software instructions which, when executed by the processor of the computer system, cause the processor to transmit a predetermined incentive offering to the patron after the receipt of patron feedback by the computer system.

14. The computerized system of claim 13, also comprising software instructions which, when executed by the processor of the mobile computing device, cause the processor of the mobile computing device to store the predetermined incentive offering in a storage device for later use by the patron.

15. The computerized system of claim 9, where the software instructions which provide the analyzed feedback in real-time to at least one recipient predetermined by the restaurateur comprise software instructions that:
configure the processor of the computer system to form a web page, accessible to recipients predetermined by the restaurateur; and
configure the processor to display the analyzed feedback in the formed web page.

16. The computerized system of claim 9, where the software instructions which provide the analyzed feedback in real-time to at least one recipient predetermined by the restaurateur comprise software instructions that configure the processor of the computer system to accumulate the analyzed feedback data and after a predetermined time interval, transmit a message to at least one predetermined recipient comprising a summary of the analyzed feedback data.

17. The computerized system of claim 16, where the software instructions which provide the analyzed feedback in real-time to at least one recipient predetermined by the restaurateur further comprise software instructions that:
configure the processor of the computer system to analyze feedback data and identify feedback results which fall outside of a predetermined range; and
configure the processor to transmit instant messages to predetermined recipients if feedback is identified which falls outside of the predetermined range.

18. A computerized method of collecting patron feedback and providing that patron feedback to a restaurateur in real-time comprising the steps of:
receiving feedback, at a computer system, from a patron of an establishment where the patron uses a mobile computing device to transmit the feedback;
determining, using the computer system, the location of the establishment for which feedback is being received;
analyzing, using the computer system, the received feedback to determine characteristics of the establishment that caused a negative feedback from the patron; and
communicating in real-time to recipients predetermined by the restaurateur, using the computer system, characteristics determined to have caused negative feedback from the patron.

19. The computerized method of claim 18, where the step of determining the location of the establishment for which feedback is being received comprises the steps of:
receiving, at the computer system, an indication of the location of the mobile computing device; and
determining, using a database of establishments and the location of the mobile computing device, the location of the establishment for which feedback is being received.

20. The computerized method of claim 18, where the step of communicating characteristics determined to have caused negative feedback from the patron comprises the step of transmitting a summary of the characteristics to at least one predetermined recipient using an instant message.
